(19) United States
(12) Patent Application Publication
(10) Pub. No.: US 2004/0054604 A1
(43) Pub. Date: Mar. 18, 2004

(54) Method and system for marketing of product and a reward function

(75) Inventors: Jane Frejlev, Singapore (SG); Mikko Makipaa, Helsinki (FI); Peter Stepman, Helsinki (FI); Mikko Tarkiainen, Espoo (FI); Marko Vanska, Shanghai (CN)

Correspondence Address: Crawford Maunu PLLC, Suite 390, 1270 Northland Drive, St. Paul, MN, 55120, US

(73) Assignee: Nokia Corporation

(21) Appl. No.: 10/607,833

(22) Filed: Jun. 27, 2003

Related U.S. Application Data
(63) Continuation of application No. PCT/FI01/01113, filed on Dec. 17, 2001.

(30) Foreign Application Priority Data
Dec. 29, 2000 (FI) 20002901

(51) Int. Cl. G06F 17/60

(52) U.S. Cl. 705/26; 705/14

(57) ABSTRACT

A method and system for collecting data on a user of communication device into a customer register. A product of a consumer carries out active marketing by transmitting a product code to its environment. The user of the communication device receives the product code when he retrieves the product data corresponding to the product code from a server or when he performs a purchase operation concerning the product to which said product code refers, data on the user of the communication device are stored in the customer register and a reward is formed to the consumer on the basis of the realized retrieval of said product data, or said purchase operation and the product code referring to the identity codes of the consumer.

This application is a Continuation of International Application PCT/FI01/01113 with an international filing date of Dec. 17, 2001 (17.12.2001), which designated the U.S. and was published under PCT Article 21(2) in English, the content of which is incorporated herein by reference in its entirety.

### FIELD OF THE INVENTION

The present invention relates to a method and system for rewarding a user of a product for marketing the product.

### BACKGROUND

For merchants and manufacturers, it is important to market products or services efficiently and have more customers. A known solution for the problem is to use the purchased product for marketing purposes for instance in such a manner that the buyer of the product fills in a registration form accompanying the product and answers the questions in the form. The form may, for example, make enquiries about contact information of the customer, information on the newly purchased product or consumer habits. The customer itself profits from the registration, because he receives information on new products that are of interest just for him or on the accessories for the product he has recently bought. Also the seller and manufacturer of the product receive information on their customers and can form a customer register, whereby new products, for instance, can be directly marketed to the registered customers. The problem is to make the customer sufficiently motivated to answer the questions in the registration form and also to return said form to the seller or manufacturer of the product. A further problem is, how to utilize the registered customers that have bought the product in gaining new customers.

Known methods of utilizing registered customers in gaining new customers are used in the marketing of magazines, for instance. The customer in a customer relationship is promised to have other products or free issues as a reward for every new customer that he can make subscribe to the magazine. This can be implemented, for instance, so that the customer receives a filled-in form from the seller of the product, the form including, as information filled in beforehand, the customer information on said customer, on the basis of which the seller identifies the customer. As the customer introduces the product to a potential buyer candidate, the subscriber information on the buyer candidate, such as name, address and possibly other information required by the seller, is filled in said form. Finally said form is sent to the seller or manufacturer by post, fax or, if the form is in electronic form, by e-mail. However, the above mentioned measures require that both the customer and the potential new customer are active, which may for some customers seem cumbersome or even disagreeable.

Other known methods of utilizing customers who have bought the product in gaining new potential customers and providing the mobile station of a person interested in the product with the product information are disclosed in the Applicant's application EP1059599. By means of the mobile station, the person interested in the product can receive a product identifier of the product, transmitted, for example, by a bar code reader, SMS message transmitter or Bluetooth transmitter, and by using this product identifier, the person may get experiences of previous users of this kind of product to his mobile station. However, this method does not allow the collection of information on the mobile station user into a customer register or the rewarding of the customers that have already bought the product in a case where a potential buyer candidate, such as a mobile station user, is interested in the product or buys the product.

### SUMMARY OF THE INVENTION

A method and system are now provided for collecting data on a user of a communication means into a customer register and rewarding the owner of a product, i.e. the customer, in the marketing of the product. When a customer buys a product, a product code of said product and an identity code of the customer are stored in a database in connection with the purchase operation. A product code transmitter integrated into the product transmits the product code to its environment, whereby said product code can be received by a suitable communication device.

The product code integrated into the product is provided in the environment preferably actively by transmitting a product code signal wirelessly, which signal can be received and read by device of a receiver suitable for the purpose. Alternatively, the product code can also be provided passively by means of a remote-readable magnetic transmitter, for instance, or a passive radio transmitter which is activated by a product code reader.

The product code received in the receiver and the identity code of the user of the receiver can be forwarded to a server which has access to a database comprising a customer register. The server transmits the product code to the database where the product code is stored in the database register. As feedback, the server transmits information on the product to which the product code refers, to the user of said communication device. In addition, the server forms a reward to a reward account of the customer, i.e. the owner of the product, to which reward account said product code in said database refers.

The user of the communication device receives the feedback information from the server and, if desired, buys the product and carries out the purchase operation either immediately or later, in which case the information on the purchase operation can be transferred to the database, whereby the customer that has bought the product earlier can be rewarded on the basis of the performed purchase operation and the product code of the product of said customer.

The advantages of the method and system of the invention relate to the customer that has bought the product, the possible potential customer interested in the product and the seller and manufacturer of the product. The customer that has bought the product can, if he wants to, introduce the product to a potential buyer candidate or act entirely passively, in which case the person interested in the product can, after receiving the product code of the product by means of a suitable device, decide whether he possibly wants to have additional information on the product and consider buying the product or even make the decision to buy the product immediately.

The seller and manufacturer of the product benefit from the method and system of the invention by receiving information on potential customers interested in the products. The marketing can then be directly focused on the target group, which may reduce marketing costs considerably. The seller or the manufacturer can also direct the marketing at such customers, the product codes of whose products are often referred to, for example by potential buyer candidates or in connection with new purchase operations, and thus there are even better chances of marketing their products.

A first aspect of the invention provides a method of collecting data on a mobile station user into a customer register, comprising a product, the product comprising a product code and a product code transmitter, a database for maintaining the customer register of the product code and the identity code of the owner of the product, and at least one mobile station capable of receiving said product code, the method comprising the steps of receiving said product code by means of the mobile station characterized by, in the method further transmitting the product code received by means of the mobile station and the identity code of said mobile station and user data pre-stored in the mobile station through a communication network to a server, storing said identity code and said user data on the mobile station user by means of the server in said database customer register to form the customer register.

A second aspect of the invention provides a system for collecting data on a mobile station user into a customer register, comprising a product, the product comprising a product code and a product code transmitter, a database for maintaining the customer register of said product code and an identity code of the owner of the product, and at least one mobile station capable of receiving said product code, and reception means for receiving the product code by means of the mobile station, characterized in that the system further comprises transmission means for transmitting the product code received by means of the mobile station, the identity code of said mobile station and user data pre-stored in the mobile station through a mobile communication network to a server, storing means for storing said identity code and said user data with the server in said database customer register to form the customer register.

A third aspect of the invention provides a device for collecting data on a mobile station user into a customer register, comprising a database for maintaining the customer register of a product code transmitted by a product code transmitter and an identity code of the owner of the product, characterized in that the device further comprises reception means for receiving the product code received by means of the mobile station, the identity code of said mobile station and user data pre-stored in the mobile station through a mobile communication network, storing means for storing said identity code and said user data in said database customer register to form the customer register.

A fourth aspect of the invention provides a computer program product for collecting data on a mobile station user into a customer register, the computer program product comprising computer program means for maintaining in a database the customer register of a product code transmitted by a product code transmitter of the product and an identity code of the owner of the product, characterized in that the computer program product further comprises computer program means for receiving the product code received by means of the mobile station, the identity code of said mobile station and user data pre-stored in the mobile station, computer program means for storing said identity code and said user data in said database customer register.

### BRIEF DESCRIPTION OF THE DRAWINGS

In the following invention will be described in detail with reference to the attached drawings, in which

FIG. 1 illustrates a flow chart of a method according to an embodiment,

FIG. 2 illustrates a block diagram of a database of a system according to an embodiment of the invention,

FIG. 3 illustrates a block diagram of a server of a system according to an embodiment of the invention,

FIG. 4 illustrates a system according to an embodiment of the invention,

FIG. 5 illustrates a diagram of a communication means according to an embodiment of the invention,

FIG. 6 illustrates how a connection according to an embodiment of the invention is established between a transmitter and a receiver.

### DETAILED DESCRIPTION

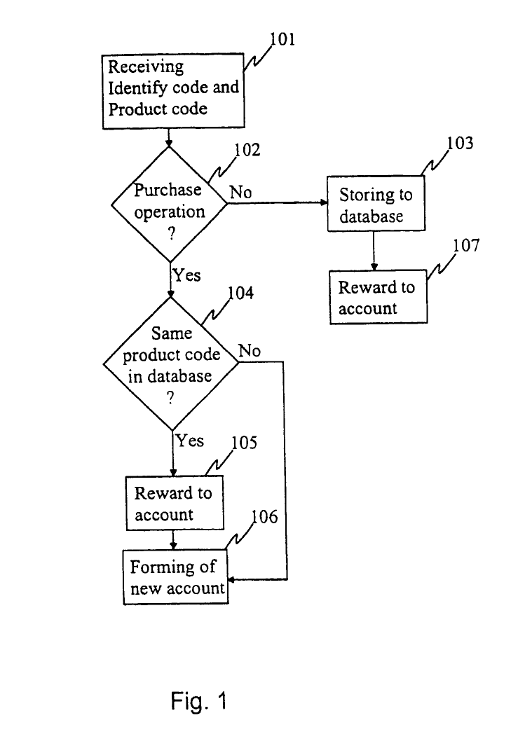

FIG. 1 illustrates a flow chart of a method according to the invention. In step 101, a mobile station user identity code transmitted by a mobile station and a product code are received with a server, for instance. The identity code can be, for instance, an identifier identifying the buyer of the product or an identifier identifying the person interested in the product, such as the mobile station user, and the product code can be an identifier identifying the product purchased.

In step 102, it is checked whether this is a purchase operation or whether only additional information is required on the product to which said product code refers. If this is a purchase operation, the product code received is compared to a product code register of a database in step 104, and if said product code received corresponds to the product code in the product register, referring to the identity code of a customer in the customer register, the process proceeds to step 105 where, in response to the performed comparison, a reward is paid to the reward account to which said product code in the database refers, and the process proceeds to step 106. If said correspondence cannot be detected in step 104, the process proceeds to step 106. In step 106, the buyer's identity code and the product code of the product said buyer has bought are stored in the database, said product code is set to refer to said identity code and the database is also provided with a reward account referring to said product code and said identity code of the buyer.

If no purchase operation is performed in step 102, for example when the mobile station user, i.e. the potential buyer candidate, is only interested in having additional information on the product, the process proceeds to step 103 where the identity codes of the potential buyer candidate are stored in database registers reserved for them, for example a customer profile register and a product code register, and said product code is set to refer to said identity code. In step 107, a reward is formed to the reward account of the customer, to which reward account said product code received in step 101 refers. Said reward to be formed to the customer's reward account can be similar, equal, smaller or bigger than the reward paid in step 105. The reward to be formed in steps 105 and 107 can be formed by the product seller to the customer, or also by the product manufacturer to the product seller to which said product code is set to refer.

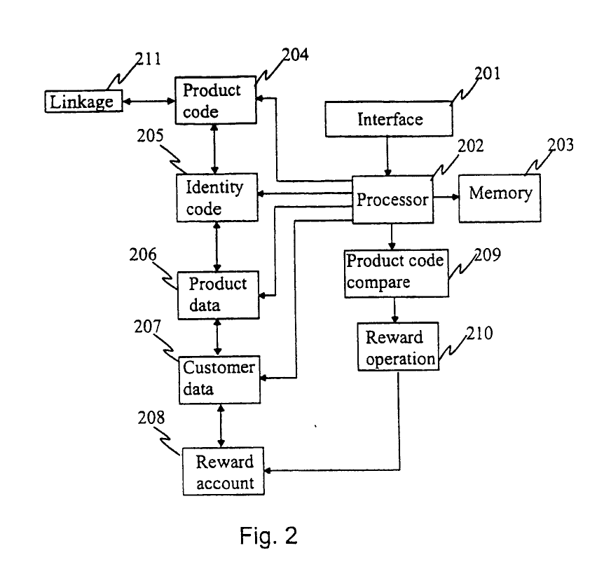

FIG. 2 illustrates a block diagram of a database of a system according to the invention. The database comprises an interface 201 for transmitting information, such as a mobile station identity code, product code and product data, between the database and, for instance, a mobile station, telecommunication network or server, means, such as a processor 202 and a memory 203, for performing database functions. The database further comprises a customer register comprising the following registers linked with each other: a product code register 204 for storing product codes, an identity code register 205 for storing identity codes of customers, a product data register 206 for storing, for example, technical information and price information on products, a customer data register 207 for storing customer profiles, for instance, and a reward register 208 for storing rewards of customers. In addition, the database comprises linkage means 211 for linking the registers 204 to 208 with each other, product code comparison means 209, by which means the received product code is compared to the product codes of the product code register 204 during the purchase operation, and reward formation means 210 for forming a reward register into a reward register, in response to a successful comparison of product codes, on the basis of said product code and the identity code to which the product code refers to. Said functional blocks of the database can alternatively be implemented as computer programs.

The product code register 204 can comprise the product code as a code, such as a sequence of numbers or characters, identifying each product item, for instance. Alternatively, the product code can be expressed, for instance, so that a specific part of the product code indicates the manufacturer or brand of the product and another specific part indicates the model of the product. The identity code register 205 can comprise a code, which may be a sequence of numbers or characters, as in the case of the product code. The product data register 206 can further comprise, for instance, information formed by the manufacturer or seller of the product, for example, the number of products available in the stores of the seller or manufacturer, and colour or size alternatives. The customer data register 207 can comprise information on the customer, such as his name, address, telephone number, regular customer number or customer number. Said register can also comprise information on the previous purchase operations of the customer or the prevailing balance or number of points in the reward account of the customer.

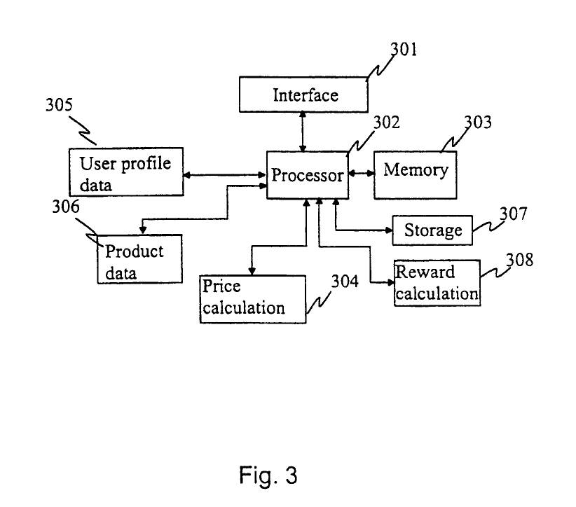

FIG. 3 illustrates a block diagram of a server of a system according to the invention. The server comprises an interface 301 to a communications network for receiving and transmitting information, such as a mobile station identity code, product code and product data, between the server and, for instance, a mobile station or database, means, such as a processor 302 and a random access memory 303 for performing server functions. The server can further comprise calculation means 304 for calculating the price of the product on the basis of, for instance, a user profile data register 305 which may contain information on the customer profile of the mobile station user, for instance. The server also comprises means 308 for calculating a reward, and a storage memory 307 for storing the information. The server may also comprise a means 306 for transmitting product data to the mobile station user by, for instance, transmitting the internet address of the manufacturer or seller on the basis of the received product code. Said functional blocks of the server can alternatively also be implemented as computer programs.

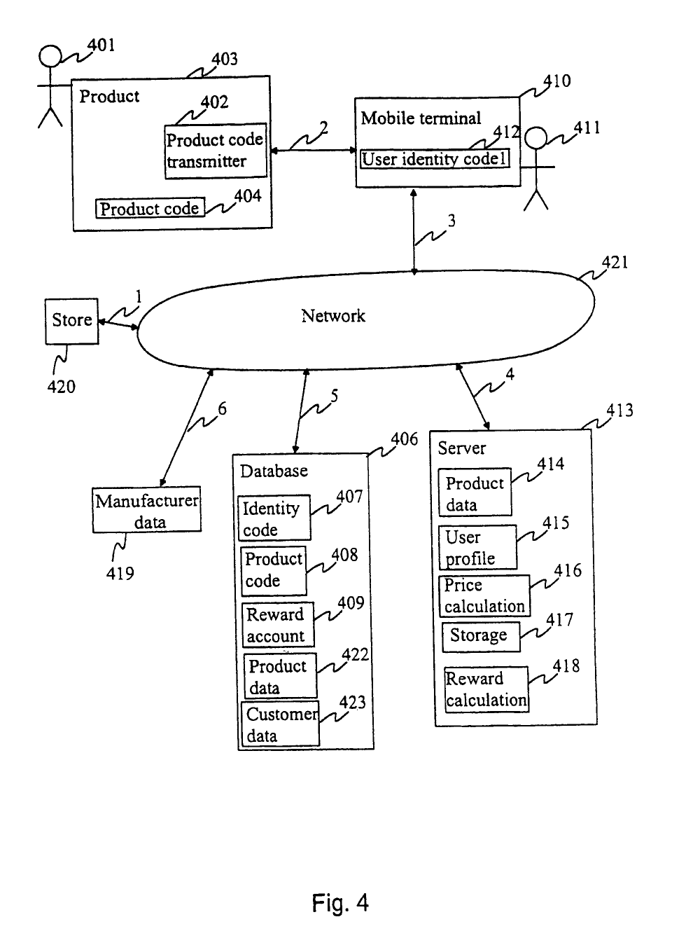

FIG. 4 illustrates an embodiment of a system according to the invention, the system comprising a product code transmitter 402 integrated into a product 403 which is bought by a customer 401. The product code transmitter 402 is preferably a radio transmitter, such as a Bluetooth transmitter or a short-range radio transmitter of another kind or other wireless transmitter, capable of establishing a connection to other wireless devices. Preferably, the transmitter actively transmits the product code as a radio-frequency signal to its environment, whereby the product code can be received in a mobile terminal 410, which may be a wireless communication device, such as a Bluetooth communication device, for instance. The active product code transmitter can be activated either in connection with the purchase operation or before that, in which case the product code can be received in the mobile terminal already when one is familiarizing with the product in the shop selling it, for instance. Alternatively the product code may be, for example, a bar code, a magnetic transmitter, a number sequence visible to the human eye or a passive transmitter which is activated in the product when the reading device is brought to the vicinity of the product code transmitter, whereby it can be read with means suitable for reading the code and transmitted through a cable, an infrared link or a Bluetooth system to the mobile station.

If the product is not a physical product into which the product code transmitter can be integrated, but, for instance, computer software or a music record, such as a CD, MD, MP3 or other record, the product code transmitter can be placed at the product package, such as the CD box. Alternatively, the product code can be implemented in the software for example in such a manner that when the software is started in the equipment comprising means enabling the transmission of the product code, the transmitter of the equipment starts to transmit the product code to its environment. Correspondingly, the use of an audio record or audio video record in a device comprising means for transmitting the product code causes that the product code is transmitted to the environment of the device.

In connection with the purchase operation, the product code 403 of the product is activated, and the identity codes 405 of the customer 401 and said product code 404 of the purchased product are stored in a database 406 by a product seller 420, for instance. The customer identity code is stored in a register 407, the product code of the product in a register 408, customer data, such as name and address, can be stored in a register 423, and a record is formed in a database register 409 in order to reward the customer 401, if such an event is carried out that refers to the product code 404 of the product of the customer 401 and which event is carried out by a person other than the owner 401 of the product. This event may be, for instance, a search for information on said product, performed on the basis of the product code 404, or purchase operation concerning the product to which the product code refers. There is a connection between the registers 407 to 409 in the database 406 so that on the basis of the product code, it is possible to refer to the customer 401 data and on the basis of the identity codes of the customer 401, it is possible to refer to the product codes of the products.

The product code 404 can be read by a suitable device, which is preferably a mobile station 410, such as a Bluetooth mobile station. If the mobile station user 411 needs additional information on the product 403, he can receive the product code 404 of the product of the customer 401, for instance, by taking his device (reference 410) inside the transmission range of the product code transmitter 402. The product code is transmitted with the mobile station user identity codes 412 either automatically, or manually by the mobile station user through a communication network 421 to a server 413, for instance. Said identity code can comprise, for instance, an identifier, such as a sequence of numbers or characters, in the mobile station, which identifier can, if desired, be changed by the server, if the identifier is to be stored in a database register 407, to correspond to the form of said register 407. In addition to the product code and identity code, user data predetermined by the user can alternatively be transmitted, which data, such as name and address, can be stored by means of the server in the database register 407, for instance.

The product code 404 and the mobile station user identity code 412 are received in the server and the product code 404 is transmitted, for instance, through said communication network or along other data transmission path to the database 406 to be stored, for instance, in the register 408 of the customer register of the database. Said register 408 helps to find out how often there have been references to said product code and a reward can be paid, for instance, by a seller to a reward account to which the product code refers. The identity codes 412 of the user 411 can also be stored in the register 407 of the database, whereby the seller or manufacturer of the product, for instance, can use the user 411 data for marketing purposes, for instance. On the basis of the product code 404, a reward (reference 418) is calculated to the reward account (reference 409) of the database 406, to which account said product code in the register 408 refers. In addition, the server has an access to registers which may be located in said server 413 or alternatively in said database 406, the registers comprising product data (reference 414) of the product and profile data (reference 415) on persons, such as the mobile station user. The product data may comprise, for example, the product material or the available colour or size selection of the product. The product data may also be located in the product database of the product manufacturer 419, for instance, in which case the mobile station user can find out which product versions (e.g. colour and size) or similar products (e.g. other products with different properties) are available, or the product data can alternatively also be located in the product data register 422 of the database 406. The profile data can comprise, for instance, the age, sex, residence and purchase history of the mobile station user, memberships in the regular customer programs and the objects of interest, such as music, sports, cars and motoring and other similar objects. In addition, the profile data can comprise a reference to the person's reward account 409, in which case the balance of said account can be used as a part of the profile data. Alternatively, the profile data on the mobile station user in the register 415 can also be located in the customer register 423 of the database 406.

On the basis of the profile data of said user, for instance, and the conditions set by the product seller, an individual price offer can be formed (reference 416) by means of the server for the product in which the mobile station user 411 is interested. Said price offer can be formed like in the following illustrating examples, for instance. The product seller sets a condition, according to which a person who has bought at least two CDs of a specific artist may buy a new CD of this artist at a 20% discount. If the mobile station user 411 is interested in this particular CD, the server examines the profile data of the mobile station user 411 and if said profile data reveal that the condition is fulfilled, the server calculates a reduced price for the product and transmits it to the mobile station user. In the second example, the product seller sets a condition, according to which there must be a certain balance or certain number of points in the reward account of the mobile station user in order to have a certain discount on the price of the product (2500 to 5000 points=10% discount, over 10000 points=20% discount). In this case, the number of points in the profile data is used as a variable when the price is calculated according to the algorithm formed by the seller.

Product data, such as the price and technical information of the product, corresponding to the product code 404 transmitted from the mobile station 410 are transmitted from the server to the mobile station or stored in the server memory (reference 417) to be used by the mobile station user for a later search.

After receiving the product data, the mobile station user may perform a purchase operation, which can be carried out immediately after the product data have been received by the mobile station. When the mobile station user 411 makes a purchase decision, a message of the purchase decision is transmitted through the server to the database. The product code 404 transmitted by the mobile station user is compared in the server or database to the product codes stored in the product code register 408. If a corresponding product code 408 can be found in the product code register, a reward is given to the customer 401 on the basis of the performed purchase operation and the product code 408 referring to the customer 401. The reward may be bonus points, for instance, or an entitlement to have a reduced price if the customer buys other products later, and it is stored in the reward register in said database. Simultaneously, if the mobile station user wants to, the product code of the purchased product is stored in the product code register 408 of the database 406 and a reward account (reference 409) is formed for the mobile station user and the identity code of the mobile user is stored in the database register 407.

The mobile station user 411 can also get the product from a shop selling it or order the product via the product seller, for instance, or the internet services of the manufacturer. The product code 404 and the identity codes 412 of the mobile station user 411 are already stored in the database 406, if the mobile station user has carried out a product data search on the basis of said product code 404. If the mobile station user wants to, the product code of the purchased product is stored in the product code register 408 of the database 406 and a reward account (reference 409) is formed for the mobile station user and the identity code of the mobile station user is stored in the database register 407.

Alternatively, the product code 404 can be transmitted from the mobile station 410 also in encrypted form such that the user 411 signs the product code in the mobile station by using a private key in the encryption and transmits the product code and its own identity code to the server 413.

In the server, the signature is verified by using a public key stored in the server of the user 411. If the signature is acceptable and the user 411 can be found in the database 413, the authenticity of the user 411 is thus known. In this way, such misuses, among others, can be prevented where the owner of the product would try to benefit from directing the product data search, for example, to his own product.

An alternative embodiment for transmitting product data corresponding to the product code is a product code server, which stores to which product a product code corresponds. Whenever information on the product represented by the product code is required, an inquiry is made to the server, which product is in question. The product codes can thus be, for example, sufficiently long number sequences which identify the product item, or alternatively a part of the product code identifies the product and a part identifies the product item, and when the product is manufactured, it would be provided with a product number and the server would be informed that this product number corresponds to the product. In addition, the server can contain the information on the internet address which gives additional information on the product.

In the following, operation of the system according to FIG. 4 is described by way of example. The customer 401 buys the product 403 from a shop 420 where a product code transmitter 402 is activated to transmit the product code to its environment if it is not already in operation at this stage. In addition, customer identity codes are also formed and they are transferred (step 1) with the product code of the product through the communication network 421 to the database 406 (step 5). Simultaneously, a reward account 409, for instance, or other similar record is formed for said customer to a database 505 in order to pay the reward paid by the seller or manufacturer to the customer.

The customer 401 goes out of the shop to the street where the product code transmitter 402 transmits the product code to its environment (step 2). The user 411 of the mobile station 410 notices the product 403, becomes interested in it and switches his mobile station, for instance by means of an application, to operate in such a manner that the mobile station is capable of receiving the product code transmitted by the product 403. The mobile station user wants to have additional information on the product and transmits (steps 3 and 4) the product code he has received and his own identity code, which is preferably ready in the mobile station, through the communication network to the server 413. The server receives the product code and the identity code (step 4) and forwards them to the database (steps 4 and 5) where the mobile station user identity code is stored in the register 407 to be used for marketing purposed of the seller or manufacturer. The server can communicate with the database either through the network 421 or in some other way, for example by means of a fixed connection.

The server starts a reward calculation algorithm 418, wherein the product code 404 is compared to the product codes of the register 408, and if a corresponding product code is found in the register 408, referring to an identity code in the register 407, a reward can be formed to the reward account register 409 to which said product code in the register 407 refers. In this case, the product code 404 is found in the register 408, and it refers to the customer 401 identity code in the register 407, and thus a reward is formed to the register 409 of the reward account to which the identity code of the customer 401 refers. The reward calculation algorithm can also be located in the database 406 or in some other place.

The server retrieves the product 403 information the mobile station user requires by, for instance, retrieving (steps 4 and 6) the technical information on the product 403 from the product manufacturer 419 and the price of the product, colours for sale, number of products for sale or other corresponding information (steps 4 and 1) from the product seller 420. In addition, the server can calculate a reduced price (reference 416) for the product by using profile data on the user 411 in the register 415 for fixing a price. The server transmits the information to the mobile station (steps 4 and 3) or stores said information in the server memory 417, if the mobile station user, for example, does not want to receive the information at the very moment.

After receiving the information from the server, the user 411 maybe wants to order a product corresponding to the product 403, possibly having a different colour, size or different properties, in which case an order message passes from the mobile station through the communications network 421 to the server (references 3 and 4). The server forwards the order to the shop 420 (steps 4 and 1) selling the product, for instance, or to the manufacturer 419 (steps 4 and 6) through the communications network 421. The user 411 can also buy the product later in the shop 420, for instance, which sells the product. After the user 411 has carried out the purchase operation, a reward is formed for the customer 401, due to the purchase operation which has referred to his product. The reward that is to be formed for the customer 401 due to the purchase operation referring to the product code 404 is preferably bigger than a reward which is formed in a case where a reference to said product code is made when additional information is required on the product according to the product code.

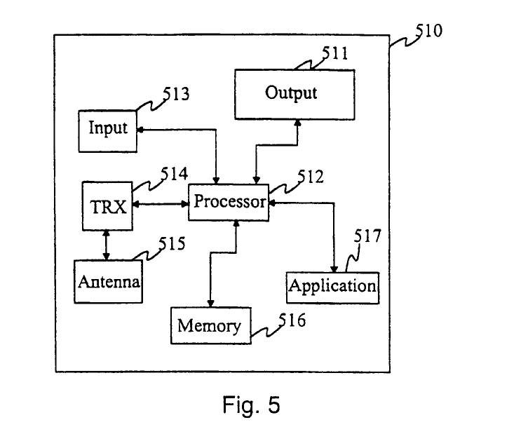

FIG. 5 illustrates a diagram of a communication means 510 according to an embodiment of the invention. The communication means comprises means 511, 513 for forming information, the means further comprising, for instance, a display and a loudspeaker by which the user can receive information audiovisually through the communication means, and a keyboard or touch screen, for example, for entering information into the communication means. The communication means can also comprise a processor 512 for performing functions of the communication means and a memory 516 for temporarily storing the received product code, for instance, means 514, 515 for receiving the information, further comprising one or more transceivers 514 and one or more antennas 515 for wireless short-range radio communication, such as Bluetooth communication, or for communicating with the mobile communication network, for instance. The communication means can further comprise one or more applications 517 for receiving said product code, for instance, by means of the antenna 515 and the transceiver 514 at the memory 516 of the communication means, and for transmitting said product code, the identity code of the communication means and data on the communication means user, possibly pre-stored in the communication means, through the communication network to the server in order to retrieve the product data corresponding to the product code to the communication means.

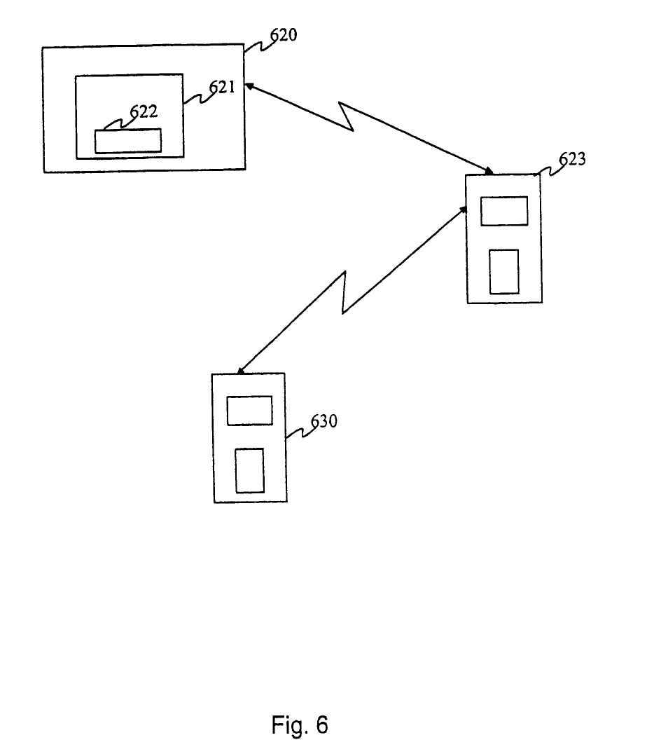

FIG. 6 illustrates how a connection according to an embodiment of the invention is established between a transmitter and a receiver. The figure shows two Bluetooth communication means (reference 623 and 630) and a product 620, the product further comprising a product code transmitter 621 and a product code 622. The product 620 and the communication means 623 and 630 are at such a distance from each other that is suitable for establishing a radio connection. In the following, it is described by way of example how a connection is established between two Bluetooth devices, wherein the first device is the communication means 623 and the second device is either the product 620 or the communications means 630.

The Bluetooth communication means 623 makes inquiries in its environment in order to establish a connection between other Bluetooth communication means or devices and to form a pico network with said communication means or devices. Before contact is made for the first time, the devices 623 and 630 or 621 are in stand-by state. During the communication establishment, the communication means 623 acts as a host and searches for the surrounding devices and exchanges information on the clock-offset, for instance, and the device addresses by transmitting a search message, and when the communication means 630 or the product code transmitter 621 receives said search message, an SDP session (Service Discovery Protocol) starts between said communication means. Search messages are used for establishing a connection when the address of the destination device is known. Correspondingly, inquiry messages transmitted after the search messages are used when the address of the destination is unknown. During the SDP session, all the information required for establishing a Bluetooth connection is collected from the product code transmitter 621 of the product 620 or from the communication means 630 to the communication means 623. The information required for establishing a connection can comprise a Bluetooth class of the devices, for example, because Bluetooth devices must be capable of identifying each other and finding out the abilities and properties of the devices they have identified. Since the Bluetooth technique is applicable to very different devices, all devices are not expected to have the same abilities. Therefore, the devices have been divided into classes, each of which supports a specific number of properties. In this way, software modules suitable for communication can be taken into use, depending on the devices between which the communication takes place. After the information required for establishing a Bluetooth communication is collected, a free radio channel can be taken into use for the connection, and the communication means 623 can start communicating, such as transmitting data with the communication means 630, or receiving product codes from the product code transmitter 621. When the link between the devices 623 and 630, or between the devices 623 and 621, is terminated, one of the parties transmits an LMP detach message (Link Manager Protocol) which terminates the connection between the parties.

The implementation and embodiments of the invention have been described herein by means of examples. It is obvious to a person skilled in the art that the invention is not restricted to the details of the above described embodiments and that the invention may also be implemented in another form, without deviating from the characteristics of the invention. The presented embodiments should be regarded as illustrative, but not restrictive. Thus, the implementation and use of the invention are only limited by the attached claims. Consequently, the different embodiments of the invention, including equivalent embodiments, as defined by the claims, are within the scope of the invention.

What is claimed is:

1. A method for collecting data on a communication device user into at least one register of a customer register, comprising a product, the product comprising a product code and a product code transmitter for wirelessly transmitting the product code, a database for maintaining the customer register of said product code and at least one communication device capable of receiving said product code, the method comprising:
receiving said product code by means of the communication device;
transmitting the product code received wirelessly by means of the communication device and an identity code of said communication device and user data pre-stored in the communication device from the communication device through a communication network to a server; and
storing said identity code and said user data on the communication device user by means of the server in said at least one register.

2. A method as claimed in claim 1, further comprising comparing said product code to product codes that already exist in said database and forming a reward in response to said comparison.

3. A method as claimed in claim 2, wherein forming a reward comprises forming said reward when the communication means user performs a purchase operation on the basis of said product code.

4. A method as claimed in claim 1, further comprising forming a reward in response to the received data on the communication device user.

5. A method as claimed in claim 4, wherein forming a reward comprises forming said reward to the communication device user.

6. A method as claimed in claim 3, wherein forming a reward comprises forming said reward to a reward account to which said received product code refers.

7. A method as claimed in claim 4, wherein forming a reward comprises forming said reward to a reward account to which said received product code refers.

8. A method as claimed in claim 6, wherein the reward account comprises the reward account of the owner of said product.

9. A method as claimed in claim 1, further comprising linking the information of said customer register with each other.

10. A system for collecting data on a communication device user into at least one register of a customer register, comprising:
a product, the product comprising a product code and a product code transmitter for wirelessly transmitting the product code;
a database for maintaining the customer register of said product code;
at least one communication device capable of receiving said product code;
reception means for receiving the product code by means of the communication device;
a server;
wherein the communication device comprises transmission means for transmitting the product code received by means of the communication device, an identity code of said communication device and user data pre-stored in the communication device through a communication network to at least one register of the customer register, and wherein the server is arranged to store said identity code and said user data in at least one register of said database.

11. A system as claimed in claim 10, further comprising product code comparison means, which means are implemented to compare said product code to product codes which already exist in said database.

12. A system as claimed in claim 11, further comprising reward formation means, which means are implemented to form a reward in response to said comparison of the product code.

13. A system as claimed in claim 12, wherein said reward formation means is implemented to form a reward when the communication device user performs a purchase operation on the basis of said product code.

14. A system as claimed in claim 10, further comprising linkage means for linking the information of the customer register with each other.

15. A device for collecting data on a mobile station user into at least one register of a customer register comprising a database for maintaining the customer register of a product code transmitted by a product code transmitter, the device comprising:
reception means for receiving the product code received by means of a wireless communication device, an identity code of said communication device and user data pre-stored in the communication device through a wireless communication network; and
storing means for storing said identity code and said user data in said at least one register of the database.

16. A device as claimed in claim 15, further comprising product code comparison means, which means are implemented to compare said product code to product codes which already exist in said database.

17. A device as claimed in claim 15, further comprising reward formation means, which means are implemented to form a reward in response to said comparison of the product code.

18. A device as claimed in claim 16, further comprising reward formation means, which means are implemented to form a reward in response to said comparison of the product code.

19. A computer program product for collecting data on a communication device user into a customer register, the computer program product comprising computer program means for maintaining in a database the customer register of a product code transmitted by a product code transmitter of the product, wherein the computer program product further comprises computer program means for receiving the product code received by means of the communication device, an identity code of said communication device and user data pre-stored in the communication device, and computer program means for storing said identity code and said user data in said database customer register.

20. A computer program product as claimed in claim 19, wherein the computer program product further comprises computer program means for comparing said product code to product codes that already exist in the database.

21. A computer program product as claimed in claim 19, wherein the computer program product further comprises computer program means for forming a reward in response to said comparison of said product code.

22. A computer program product as claimed in claim 20, wherein the computer program product further comprises computer program means for forming a reward in response to said comparison of said product code.

23. A wireless communication device for collecting data on a communication device user into a customer register, comprising first reception means for wirelessly receiving a product code of a product, wherein the communication device further comprises transmission means for transmitting said product code, an identity code of said communication device and user data pre-stored in the communication device through a wireless communication network to a server.

24. A communication device as claimed in claim 23, wherein the communication device is arranged to receive information on the product to which the product code refers, in response to the transmitted said product code, said identity code and said user code.

25. A communication device as claimed in claim 24, wherein the communication device is a Bluetooth communication device.
